(19) United States
(12) Patent Application Publication
(10) Pub. No.: US 2026/0046801 A1
(43) Pub. Date: Feb. 12, 2026

(54) SYSTEM AND SCHEME FOR TIMING INDICATION FOR FRAME TIMING

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 19/329,152

(22) Filed: Sep. 15, 2025

Related U.S. Application Data
(63) Continuation of application No. PCT/CN2023/082667, filed on Mar. 21, 2023.

(51) Int. Cl. H04W 56/00

(52) U.S. Cl. CPC H04W 56/0015

(57) ABSTRACT

In accordance with implementations, an apparatus may receive a timing realignment indication message and use information included in the message to determine a timing reference point. By transmitting with timing based on the timing reference point, the apparatus may achieve improved frame alignment. The timing realignment indication message may be provided to the apparatus as part of communication to a plurality of such apparatus or as part of communication that is specifically directed to the apparatus.

### CROSS-REFERENCE TO RELATED APPLICATION

This application is a continuation of International Application No. PCT/CN2023/082667, filed on Mar. 21, 2023, the contents of which are hereby incorporated by reference in its entirety.

### TECHNICAL FIELD

The present disclosure relates, generally, to mobile, wireless communication and, in particular embodiments, to frame timing alignment.

### BACKGROUND

In current mobile, wireless communication networks, known methods of establishing frame timing alignment are suitable for serving applications that are used in these networks. However, it may be shown that it is challenging to establish a frame timing alignment among diverse frame structures such that the frame timing alignment is suitable for serving some of the applications that are pondered for future mobile, wireless communication networks.

One example application that is pondered for future mobile, wireless communication networks is integrated communication and sensing. In integrated communication and sensing, a first bandwidth part may use single carrier orthogonal frequency division multiple access (OFDM) for sensing and a second bandwidth part may use multi-carrier OFDM for communication. It may be shown that there will be design restrictions if there is an effort made to establish that the two types of signals are always timing-aligned based on their respective frames (slots/symbols).

### SUMMARY

Aspects of the present application relate to enabling an apparatus to achieve improved frame alignment. Notably, the frame timing alignment may comprise a timing alignment in terms of a boundary (e.g., a starting boundary or an ending boundary) of a symbol, a slot or a sub-frame within a frame; or a frame. The apparatus may receive a timing realignment indication message and use information included in the message to determine a timing reference point. By transmitting with timing based on the timing reference point, the apparatus may achieve improved frame alignment. The timing realignment indication message may be provided to the apparatus as part of communication to a plurality of such apparatus or as part of communication that is specifically directed to the apparatus.

Conveniently, aspects of the present application may be shown to support diverse frame/symbol/numerology schemes for different services without issues related to flexible frame timing alignment. In addition to frame alignment, side benefits of aspects of the present application may be shown to relate to improving clock accuracy. One result of improved frame alignment and improved clock accuracy may be improved bi-static/multi-static sensing accuracy. Additionally, apparatus in power saving mode may see a reduction in duration of uplink synchronization procedures. Improved frame alignment may be shown to reduce interference in time division duplexing applications.

According to an aspect of the present disclosure, there is provided a method. The method includes receiving, by the apparatus, signaling that carries a timing realignment indication message, the timing realignment indication message including information allowing the apparatus to determine a timing reference point for realignment and transmitting, by the apparatus, traffic in a frame, the transmitting starting from the timing reference point that has been determined based on the information.

According to an aspect of the disclosure, there is provided a non-transitory computer readable storage medium, wherein the computer readable storage medium stores instructions that, when executed by a processor of an apparatus, enable the apparatus to perform a method as described above.

According to an aspect of the disclosure, there is provided an apparatus comprising: a memory storing computer readable instructions; a receiver; a transmitter; and a processor caused, by executing the instructions, to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates various pluralities of frames transmitted by a transmit receive point and an electronic device in context with a timing reference point defined in relative terms, in accordance with aspects of the present application;

FIG. 7 illustrates various pluralities of frames transmitted by a transmit receive point and an electronic device in context with a timing reference point defined in absolute terms, in accordance with aspects of the present application;

FIG. 8 illustrates respective timelines for a transmit receive point and an electronic device, in accordance with aspects of the present application;

FIG. 9 illustrates various pluralities of frames transmitted by a transmit receive point and an electronic device in context with a timing reference point defined both in relative terms and in absolute terms, in accordance with aspects of the present application; and

FIG. 10 illustrates respective timelines for a transmit receive point and an electronic device for the electronic device transmitting a request, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

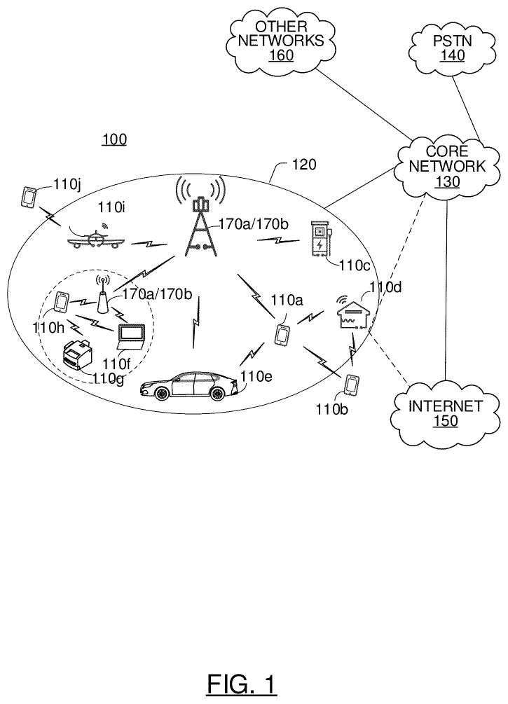

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the Internet 150, and other networks 160.

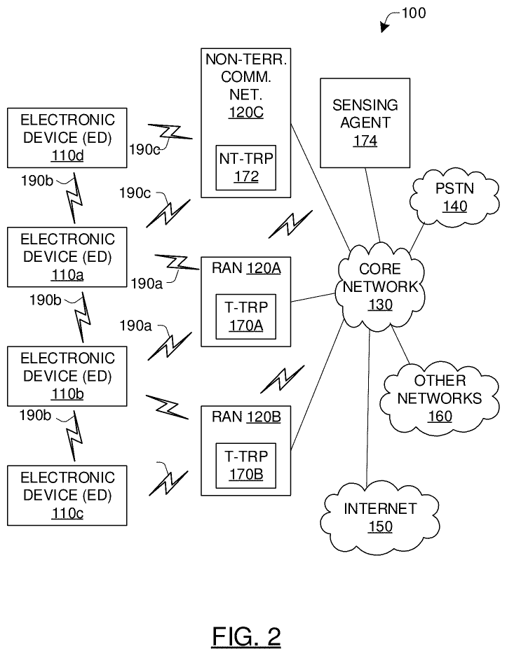

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and/or receive points (T-TRPs) 170a, 170b. The non-terrestrial communication network 120c includes an access node 172, which may be generically referred to as a non-terrestrial transmit and receive point (NT-TRP) 172. More generally, we may call any of T-TRP and NT-TRP as a base station that serves as a control node for wireless communications.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

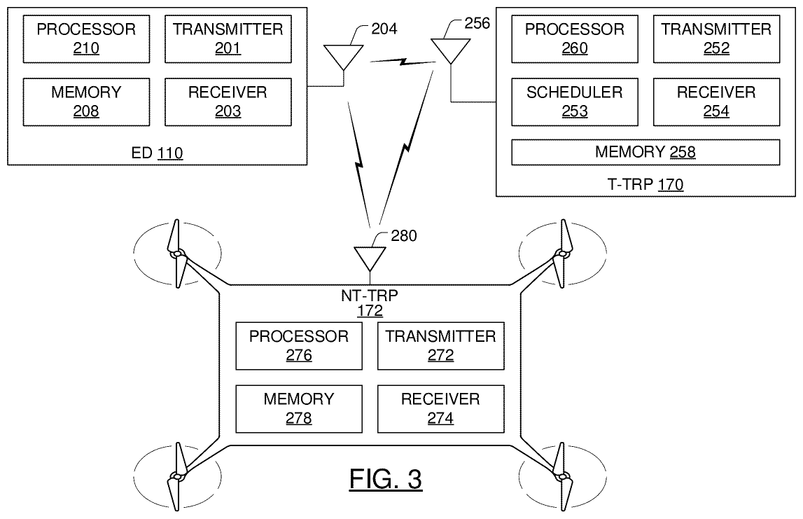

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example. The NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

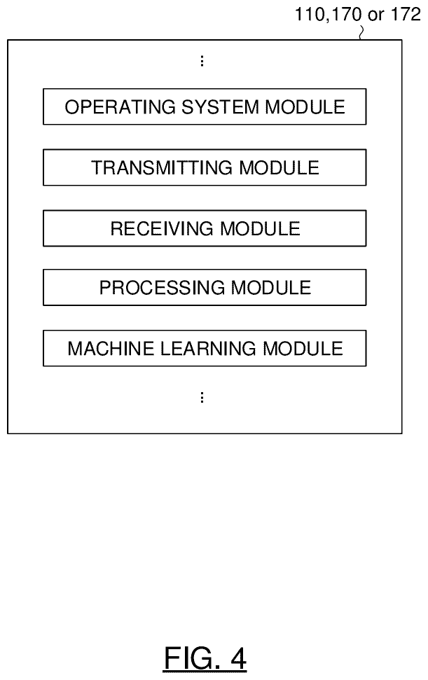

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE-specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, B/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control information (DCI) channel, or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including the UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

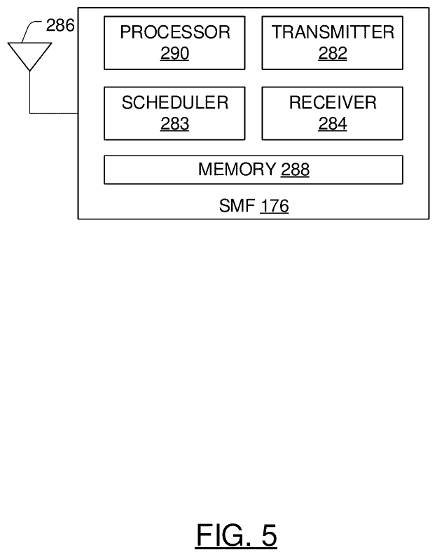

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent an SFN. When an SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

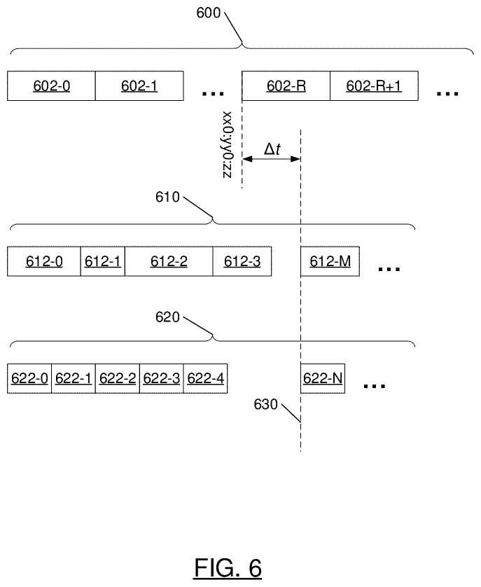

FIG. 6 illustrates a plurality 600 of frames 602-0, 602-1, . . . , 602-R, 602-R+1, transmitted by the TRP 170 and received by the UE 110. The plurality 600 of frames includes reference frames 602-0, . . . 602-R, 602-R+1. The reference frame 602-R is illustrated, in FIG. 6, as having a frame boundary timestamp, xx0:yy0:zz, indicative of the time at which the TRP 170 commenced transmission of the reference frame 602-R.

FIG. 6 illustrates a first plurality 610 of frames 612-0, 612-1, 612-2, 612-3, transmitted by the UE 110 and a second plurality 620 of frames 622-0, 622-1, 622-2, 612-3, 612-4, transmitted by the UE 110 or transmitted by a different UE. The first plurality 610 of frames may be understood to be transmitted, by the UE 110, in a first bandwidth part (BWP1). The second plurality 620 of frames may be understood to be transmitted, by the UE 110 or the different UE, in a second bandwidth part (BWP2). It may further be the case that BWP1 and BWP2 are transmitted in two sub-bands within one carrier frequency band or in two sub-bands in adjacent carrier frequency bands.

FIG. 6 illustrates a relative timing indication, Δt, in units of, e.g., seconds, anchored by the frame boundary with the timestamp, xx0:yy0:zz, where the timestamp format (xx0:yy0:zz) may indicate, e.g., the number of UTC seconds in 10 ms units, as (xx0) hours, (yy0) minutes and (zz) seconds, respectively, or as (xx0) days, (yy0) months and (zz) days, respectively. The UE 110 may monitor DL signaling for a timing realignment indication message associated with the configuration of a timing reference point. After receiving the timing realignment indication message, the UE 110 may adjust its existing frame boundary to be a new frame boundary at a timing reference point 630. FIG. 6 illustrates the timing reference point 630 that may be configured, at the UE 110, responsive to receiving the timing realignment indication message including a relative timing indication, Δt, and an SFN identifying the reference frame 602-R. The new frame boundary, at the timing reference point 630, may be understood to be time stamped with a value equivalent to xx0:yy0:zz+Δt.

Upon configuring the timing reference point 630, the UE 110 may commence transmitting traffic in a frame 612-M in BWP1, the transmitting starting from the timing reference point 630. Additionally, upon configuring the timing reference point 630, the UE 110 or the different UE may commence transmitting traffic in a frame 622-N in BWP2, the transmitting starting from the timing reference point 630.

According to aspects of the present application, a timing reference point may be expressed using absolute timing based on timing and clock reference source such as GNSS, UTC, etc. That is, the timing realignment indication message may include an absolute timing, where the absolute timing may comprise at least one of a timestamp (xx1:yy1:ww) and an absolute reference timing. The timestamp with the format xx1:yy1:ww can be understood to be the same as the format xx0:yy0:zz described above. The absolute reference timing indicates time reference with very small time granularity, e.g., 10 ns, 5 ns, 2 ns, ins, etc. In one embodiment, an absolute reference timing indicates time reference on a boundary (e.g., a starting boundary or an ending boundary) of a symbol, a slot, a sub-frame, or a frame, thus an indicative information on one or more of the symbol, the slot, the sub-frame and the frame that is (or are) associated with the absolute reference timing may be sent to a receiving end, for example, being included in the timing realignment indication message, dynamically indicated, or semi-statically configured. The absolute reference timing may or may not consider to pre-compensate for RF propagation between a base station and a UE (or UEs), depending on the UE operation configuration on measurement requirement such as UE Rx-Tx time difference measurement. Moreover, the absolute reference timing is used to correct clock time drifting or error, or/and to configure a frame boundary of an associated/reference frame (e.g., a starting or ending boundary of a symbol, a slot or a sub-frame of a frame; or a frame) as timing and transmission reference in a wireless network.

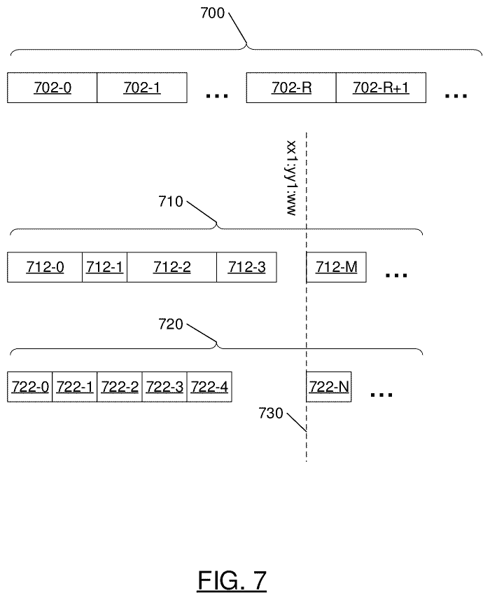

FIG. 7 illustrates a plurality 700 of reference frames 702-0, 702-1, . . . , 702-R, 702-R+1, transmitted by the TRP 170 and received by the UE 110.

FIG. 7 illustrates a first plurality 710 of frames 712-0, 712-1, 712-2, 712-3, transmitted by the UE 110 and a second plurality 720 of frames 722-0, 722-1, 722-2, 712-3, 712-4, transmitted by the UE 110 or a different UE. The first plurality 710 of frames may be understood to be transmitted, by the UE 110, in a first bandwidth part (BWP1). The second plurality 720 of frames may be understood to be transmitted, by the UE 110 or the different UE, in a second bandwidth part (BWP2). It may further be the case that BWP1 and BWP2 are transmitted in two sub-bands within one carrier frequency band or in two sub-bands in adjacent carrier frequency bands.

The UE 110 may monitor DL signaling for a timing realignment indication message associated with the configuration of a timing reference point. Indeed, as discussed hereinbefore, the timing realignment indication message may include an absolute timing, e.g., timestamp (xx1:yy1:ww) or/and an absolute reference timing (not shown in FIG. 7). After receiving the timing realignment indication message, the UE 110 may adjust its existing frame boundary to be a new frame boundary at a timing reference point 730 associated with the timestamp (xx1:yy1:ww) or/and may adjust clock timing by correcting clock time drifting or error. FIG. 7 illustrates the timing reference point 730 that may be configured, at the UE 110, responsive to receiving the timing realignment indication message. In one embodiment, if the UE 110 has an accurate local clock timing, due to either having synchronized standards timing source such as a GNSS (e.g., GPS) or having adjusted the clock timing, the UE 110 may need to get only the timestamp, xx1:yy1:ww, (e.g., from the timing realignment indication message) for a new timing realignment of a frame boundary at the timing reference point.

Upon configuring the timing reference point 730, the UE 110 may commence transmitting traffic in a frame 712-M in BWP1, the transmitting starting from the timing reference point 730. Additionally, upon configuring the timing reference point 730, the UE 110 or the different UE may commence transmitting traffic in a frame 722-N in BWP2, the transmitting starting from the timing reference point 730.

Aspects of the present application relate to transmission, by the TRP 170, of the timing realignment indication message to the UE 110. Receipt of the timing realignment indication message may be shown to cause the UE 110 to realign frame transmission to a timing reference point.

The timing realignment indication message may be transmitted, by the TRP 170, as part of DL signaling. In one aspect of the present application, the DL signaling may be implemented as cell-specific signaling. Examples of cell-specific signaling include group common signaling and broadcast signaling.

The term “group common signaling” may be interpreted as a reference to a type of DL control signaling (e.g., DCI) that is directed toward a group of UEs. The DL control signaling may be related to transmission scheduling. Alternatively or additionally, the DL control signaling may be related to notification of some info (e.g., a security warning, or incoming DL traffic from network). An example of an implementation of notification is paging signaling. It is known that a TRP 170 may schedule transmission of paging messages to a plurality of UEs 110. Paging signaling (page-group-based DCI signaling) may then be used, via PDCCH, to notify the plurality of UEs 110 of the scheduled transmissions of the paging messages. The paging messages may be transmitted, by the TRP 170, via a (data) PDSCH channel.

The term “group common signaling” may be interpreted as a reference to group-based DCI. It is known that example uses of group-based DCI include group feedback, group scheduling of transmissions, group power control and group timing advance adjustment.

The TRP 170 may use modified paging signaling, where “modified” means that a legacy paging signaling is used with one or more additional/new fields to carry the timing realignment indication message.

The TRP 170 may use new, specifically designed group common signaling with a new Radio Network Temporary Identifier (RNTI). In some embodiments, the newly designed group common signaling is dynamically transmitted with a cyclic redundancy check (CRC) that is scrambled by the new RNTI; alternatively, the newly designed group common signaling is transmitted periodically using particular time-frequency resources. Alternatively, one or more of the newly designed group common signaling can be skipped, e.g., to save transmission and reception power, by an indication in a way of dynamic signaling or semi-static configuration. For example, the indication may indicate how many times or periods to skip the group common signaling to send the timing realignment indication message or, in response to not receiving the indication, to use a default or predefined configuration of one or a series of (default or predefined) timing reference points. It is noted that, though a timing reference point is expressed in terms of a time point for timing realignment, the timing reference point is associated with a carrier frequency (band), a sub-band and a numerology that can be configured by RRC or indicated by MAC CE or dynamically in a DCI signaling.

The TRP 170 may use time-frequency resources/occasions for the group common signaling, where the occasions may comprise one or more parameters, one example parameter is periodicity. Another example parameter is the signaling location in a frame, such as a symbol offset within a slot or a slot offset with a frame, etc. Other example parameters include a frequency domain resource, which may comprise a sub-band within a carrier, a system bandwidth of the carrier, the starting location of the sub-band and a bandwidth of the sub-band. Further parameters may comprise transmission waveform and numerology, such as subcarrier spacing and/or cyclic period (CP). A UE may monitor the group common signaling from these time-frequency resources and occasions. The time-frequency resources/occasions and related parameters may be specifically configured using, for example, SIB1, RRC signaling or pre-definition in the standards.

The term “broadcast signaling” may be interpreted as a reference to a type of transmission of synchronization information (e.g., in an SSB) and/or as a reference to a type of transmission of system information (e.g., in a system information block, i.e., a “SIB”). The transmission of broadcast signaling may be considered useful for UE initial access, synchronization, cell selection, measurement, etc. Aspects of the present application relate to a UE 110 receiving a timing realignment indication message in broadcast signaling. The TRP 170 may use a modified synchronization signal block (SSB) or SIB (e.g., any of multiple SIBs in 5G network), where a legacy SSB or SIB is used with additional or added new field to carry the timing realignment indication message.

In another aspect of the present application, the DL signaling is UE-specific signaling. Examples of UE-specific signaling include unicast signaling, modified DCI signaling, modified MAC control element (MAC-CE) signaling, modified semi-static RRC signaling and modified paging signaling. Furthermore, the TRP 170 may use new, as-yet-undefined UE-specific signaling with a new RNTI.

In one embodiment, the TRP 170 may send paging notification signaling in a DL control channel such as PDCCH, wherein the paging notification signaling indicates that there is a page message to come while the paging notification signaling carries the timing realignment indication message. In another embodiment, the TRP 170 may send paging notification signaling in a DL control channel such as PDCCH, wherein the paging notification signaling indicates that there is a page message to come and the TRP 170 then may send the page message in a data channel (PDSCH) where the page message carries the timing realignment indication message.

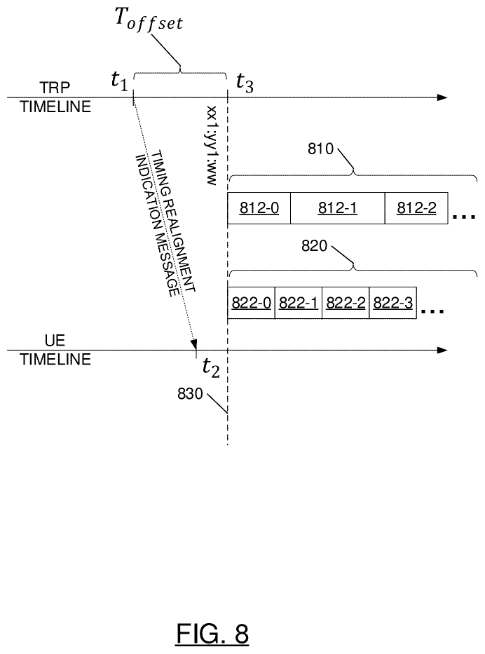

FIG. 8 illustrates a timeline for a TRP 170 and a timeline for a UE 110. In a scenario illustrated in FIG. 8, a timing realignment indication message is transmitted, by the TRP 170, at a first time, t₁, on the timeline for the TRP 170. The timing realignment indication message is illustrated, in FIG. 8, as being received, at the UE 110, at a second time, t₂, on the timeline for the UE 110. The timing realignment indication message may be transmitted, by the TRP 170, using DL signaling and may, as discussed hereinbefore, indicate a timing reference point 830. The timing reference point 830 is illustrated, in FIG. 8, as corresponding to a third time, t₃, on the timeline for the TRP 170.

Notably, the DL signaling is illustrated as being transmitted a time offset, T_{offset}, before the timing reference point 830. The value for the time offset, T_{offset}, may be determined as a difference between t₃ and t₁, that is, the time offset, T_{offset}=t₃−t₁. It may be shown that, in cases wherein the time offset, T_{offset}, is suitably large, the UE 110 has time to receive and process the timing realignment indication message before carrying out frame timing realignment. The time offset, T_{offset}, may be configured to be a minimum time offset that larger than the biggest propagation delay between the TRP 170 and any of the plurality of UEs 110 being served in a cell associated with the TRP 170. A value for the time offset, T_{offset}, may be configured by RRC signaling. A value for the time offset, T_{offset}, may be predefined. A value for the time offset, T_{offset}, may be also included in the timing realignment indication message.

The new frame timing alignment starts for both the UE 110 and the TRP 170 from the timing reference point 830, where the start frame boundary timestamp is xx1:yy1:ww.

It may be shown that, for a particular device (e.g., the TRP 170 or the UE 110) or for a whole cell, a given frame boundary timestamp may not be very accurate. In general, the degree to which a frame boundary timestamp for a given frame at the TRP 170 is synchronized with a frame boundary timestamp for the given frame at the UE 110 may be shown to deteriorate over time. The deterioration may be understood to be due, at least in part, to a drifting of a clock local to the UE 110. The deterioration may also be understood to be due to a timing error associated with cause distinct from local clock drifting. Accordingly, in conjunction with taking steps to cause timing realignment, steps may also be taken to adjust the local clock to, thereby, enhance the degree to which the frame boundary timing at the TRP 170 is synchronized with the frame boundary timing at the UE 110.

According to aspects of the present application, the timing realignment indication message, which, according to aspects of the present application, includes enough information for a UE 110 to configure a timing reference point for allowing a timing realignment at one or more UEs 110 in a cell, may also include information that may be used, at the UE 110, to compensate for clock-based timing errors.

In summary for any of FIG. 6-8, the timing realignment indication message may comprise a relative timing indication or/and an absolute timing indication; furthermore, or alternatively, the timing realignment indication message may indicate an absolute reference timing used to correct clock time drifting or error.

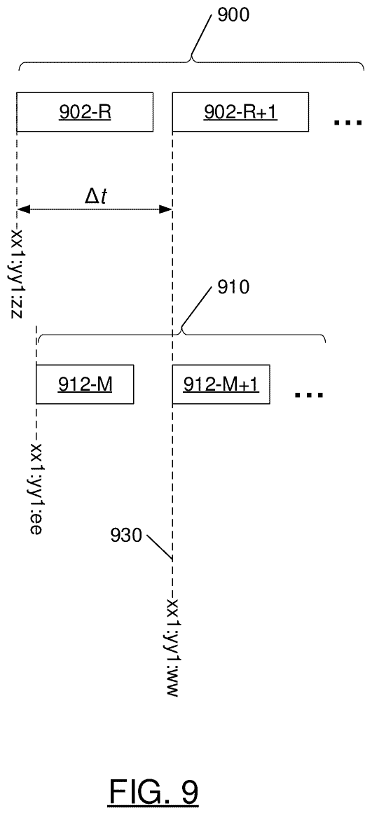

FIG. 9 illustrates a plurality 900 of frames 902-R, 902-R+1, transmitted by the TRP 170 for receipt by the UE 110. A frame boundary for a reference frame 902-R, among the plurality 900 of frames, is associated with a reference frame timestamp, xx1:yy1:zz. FIG. 9 illustrates a plurality 910 of frames 912-M, 912-M+1, transmitted by the UE 110 for receipt by the TRP 170. A frame boundary for a particular frame 912-M, among the plurality 900 of frames, is associated with a particular frame timestamp, xx1:yy1:ee. Indeed, it may be considered that the UE 110 is out of synchronization with the TRP 170 by a duration that may be obtained by finding a difference, xx1:yy1:ee-xx1:yy1:zz.

FIG. 9 illustrates a timing reference point 930 associated with a timing reference point timestamp, xx1:yy1:ww.

In one aspect of the present application, the timing realignment indication message may identify the timing reference point 930 in two distinct ways. The timing realignment indication message may identify a timing reference point 930 by including, as discussed hereinbefore, a relative timing indication, Δt, to a boundary of a symbol, a slot or a sub-frame of a reference frame, or a reference frame such as the reference frame 902-R. Additionally, the timing realignment indication message may also include an SFN of the reference frame, so that the UE 110 may properly identify the reference frame, e.g., 902-R. The timing realignment indication message may also identify the timing reference point 930 by including, as discussed hereinbefore, an absolute timing indication, e.g., the timing reference point timestamp, xx1:yy1:ww.

Optionally, the timing realignment indication message may include other parameters. The other parameters may, for example, include a time offset, discussed hereinbefore as T_{offset}. The time offset may establish a duration of time preceding the timing reference point 930. The UE 110 may rely upon the time offset, T_{offset}, as an indication that DL signaling including the timing realignment indication message will allow the UE 110 enough time to detect/decode the timing realignment indication message for configuring the timing reference point 930.

In conjunction with transmitting the timing realignment indication message, the TRP 170 may take one or more actions to correct TRP-side clock timing error with the absolute timing indication, e.g., by a quantity of xx1:yy1:ww-Δt-xx0:yy0:zz, if applicable.

In conjunction with configuring the timing reference point 930 on the basis of information received in the timing realignment indication message, the UE 110 may also take one or more actions to correct UE-side clock timing error with the absolute timing indication, e.g., by a quantity of xx1:yy1:ww-Δt-xx0:yy0:ee, if applicable.

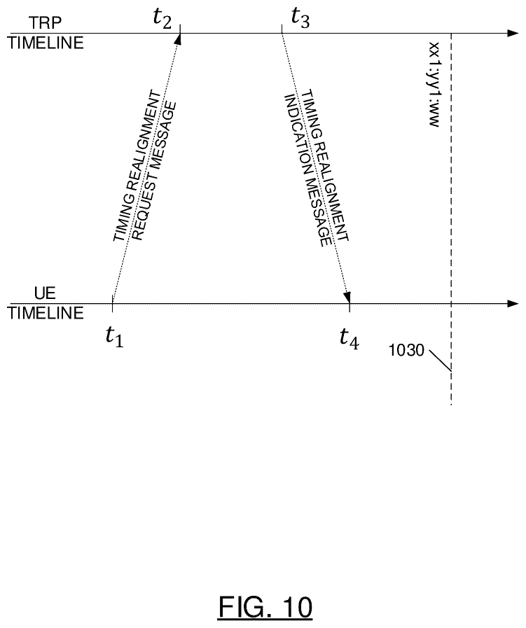

According to aspects of the present application illustrated in FIG. 10, the UE 110 sends a request message in a UL channel, i.e., either a control channel or a data channel (with piggyback) in a different way at a time t₁. The TRP 170 may detect and decode the request message received, from the UE 110, a time t₂. The TRP 170 may send, to the UE 110, a timing realignment indication message via UE-specific signaling at a time t₃. The UE 110 may detect and decode the timing realignment indication message received at a time t₄. The UE 110 may then execute the timing realignment at the timing reference point and/or carry out other timing correction for, e.g., clock time drifting or error accordingly. The details of schemes and procedures are described below.

In FIG. 10, the UE 110 may transmit, to the TRP 170, a timing realignment request message. The timing realignment request message may be interpreted, at the TRP 170, as a request for information that will allow the UE 110 to establish a new timing reference point for a frame boundary realignment or/and to correct timing errors such as clock time drifting. The UE 110 may transmit the timing realignment request message in response to recognizing that the UE 110 should take steps to correct UE-side clock timing drifting or another type of timing error. The UE 110 may transmit the timing realignment request message when the UE 110 has a perceived need for accurate reference timing or absolute timing. This need may be perceived as the UE 110 prepares to perform a sensing operation.

Three example reasons are contemplated for the UE 110 to transmit the timing realignment request message.

In a first example reason, it is assumed that the UE 110 has maintained appropriate frame time alignment but that the UE 110 has a perceived need for clock timing error correction. In a second example reason, it is assumed that the UE 110 has maintained appropriate clock synchronization but that the UE 110 has a perceived need for frame realignment. In a third example reason, the UE 110 has a perceived need for both frame realignment and clock timing error correction.

In the context of the first example reason, the UE 110 may indicate a need for clock timing error correction only. The UE 110 may include, in the timing realignment request message, an indication of an identity (e.g., an SFN) of a given frame as well as a frame boundary timestamp (e.g., xx0:yy0:ee) for the given frame.

Responsive to receiving the timing realignment request message, the TRP 170 may determine a frame boundary timing correction by finding a difference between the frame boundary timestamp (e.g., xx0:yy0:ee) provided, by the UE 110, for the given frame and a frame boundary timestamp (e.g., xx1:yy1:zz) expected, by the TRP 170, to have been established for the given frame. The TRP 170 may then transmit a timing realignment indication message. The timing realignment indication message may include an indication of a clock timing correction with a value, e.g., xx0:yy0:ee-xx1:yy1:zz.

In the context of the second example reason, the UE 110 may transmit a timing realignment request message that indicates a need for frame realignment. Responsive to receiving the timing realignment request, the TRP 170 may transmit a timing realignment indication message.

The timing realignment indication message may identify a timing reference point by including, as discussed hereinbefore, a relative timing indication, Δt, in conjunction with an SFN, so that the UE 110 may properly identify the reference frame with the frame boundary that serves as a basis for the relative timing indication, Δt. The timing realignment indication message may, alternatively, identify a timing reference point 1030 by including, as discussed hereinbefore, an absolute timing indication, e.g., a timing reference point timestamp, XX1:yy1:ww.

In the context of the third example reason, the UE 110 may transmit a timing realignment request message that indicates a need for clock timing error correction and a need for frame realignment. Responsive to receiving the timing realignment request, the TRP 170 may transmit a timing realignment indication message.

The timing realignment indication message may, as described hereinbefore, identify a timing reference point in two distinct ways. The timing realignment indication message may identify the timing reference point by including, as discussed hereinbefore, a relative timing indication, Δt, that is anchored to the frame boundary for a reference frame. Additionally, the timing realignment indication message may also include an SFN, so that the UE 110 may properly identify the reference frame. The may also identify the timing reference point by including an absolute timing indication, i.e., the timing reference point 1030 timestamp, xx1:yy1:ww. This trio of information (Δt, SFN and timestamp) may be shown to allow the UE 110 to take steps both to correct the clock timing error and to carry out a frame realignment at the timing reference point.

There are many options available, to the UE 110, for transmitting the timing realignment request message. The UE 110 may use an UL control channel or a data channel. In one option, the UE 110 may transmit the timing realignment request message within a Scheduling Request (SR) message. In another option, the UE 110 may transmit the timing realignment request message within a Buffer Status Report (BSR) message.

In a further option, the UE 110 may transmit the timing realignment request message as part of a Random Access Channel (RACH) procedure. Indeed, the UE 110 may employ a 2-step RACH procedure or a 4-step RACH procedure. In the case of the 2-step RACH procedure, the UE 110 may include the timing realignment request message in RACH MSG A. In the case of the 4-step RACH procedure, the UE 110 may include the timing realignment request message in RACH Msg 3.

It is contemplated that the timing realignment indication message may include parameters that go beyond the values discussed hereinbefore. In addition to the values (Δt, SFN and timestamp) discussed hereinbefore, the timing realignment indication message may include a clock quality indication. That is, the timing realignment indication message may include a clock quality indication parameter indicating an accuracy for the clock at the TRP 170. More particularly, the clock quality indication parameter may indicate that the clock at the TRP 170 is traceable to a GNSS or to UTC. Alternatively, the clock quality indication parameter may indicate that the clock at the TRP 170 is not traceable to an external reference, that is, that the clock is “free run.”

The clock quality indication parameter may indicate a synchronization source. For a clock at a UE 110, the synchronization source may be the TRP 170 that is serving the UE 110. The clock quality indication parameter may indicate that a GNSS is the synchronization source. The clock quality indication parameter may indicate that a UTC is the synchronization source.

In contrast to including these various parameters in the timing realignment indication message, it is further contemplated that these various parameters may be provided to the TRP 170 and to the UE 110 using RRC signaling. It should be appreciated that the (timing) realignment of transmitted frames at the timing reference point may comprise a timing realignment from (starting or ending boundary of) a symbol, a slot or a sub-frame within a frame; or a frame at the timing reference point for one or more UEs and one or BSs (in a cell or a group of cells); also, the relative timing may comprise a timing offset relative to (starting or ending boundary of) a symbol, a slot or a sub-frame within a reference frame; or a reference frame, where the reference number can be indicated by an SFN.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, by an apparatus, signaling that carries a timing realignment indication message, the timing realignment indication message including information allowing the apparatus to determine a timing reference point for realignment; and
transmitting, by the apparatus, traffic in a frame, the transmitting starting from the timing reference point determined based on the information.

2. The method of claim 1, wherein the information indicates a relative timing and a frame number for a reference frame to which the relative timing relates, and wherein the relative timing is relative to a boundary of a symbol of the reference frame, a slot of the reference frame, a sub-frame of the reference frame, or the reference frame.

3. The method of claim 1, wherein the information comprises an absolute timing indication, and wherein the absolute timing indication indicates at least one of a timestamp or an absolute reference timing.

4. The method of claim 1, wherein the signaling comprises group common signaling in a control channel, and wherein the control channel comprises a physical downlink control channel.

5. The method of claim 1, the receiving the signaling comprising:
receiving paging notification signaling, wherein the paging notification signaling indicates that there is a page message to come.

6. The method of claim 5, wherein the paging notification signaling is the signaling that carries the timing realignment indication message, or wherein the paging notification signaling indicates that there is the timing realignment indication message to come.

7. An apparatus comprising:
at least one processor coupled with a non-transitory processor readable medium storing instructions that, when executed by the at least one processor, cause the apparatus to perform operations including:
receiving signaling that carries a timing realignment indication message, the timing realignment indication message including information allowing the apparatus to determine a timing reference point for realignment; and
transmitting traffic in a frame, the transmitting starting from the timing reference point determined based on the information.

8. The apparatus of claim 7, wherein the information indicates a relative timing and a frame number for a reference frame to which the relative timing relates, and wherein the relative timing is relative to a boundary of a symbol of the reference frame, a slot of the reference frame, a sub-frame of the reference frame, or the reference frame.

9. The apparatus of claim 7, wherein the information comprises an absolute timing indication, and wherein the absolute timing indication indicates at least one of a timestamp or an absolute reference timing.

10. The apparatus of claim 7, wherein the signaling comprises group common signaling in a control channel, and wherein the control channel comprises a physical downlink control channel.

11. The apparatus of claim 7, the receiving the signaling comprising:
receiving paging notification signaling, wherein the paging notification signaling indicates that there is a page message to come.

12. The apparatus of claim 11, wherein the paging notification signaling is the signaling that carries the timing realignment indication message, or wherein the paging notification signaling indicates that there is the timing realignment indication message to come.

13. The apparatus of claim 11, wherein the page message is received in a data channel, wherein the page message carries the timing realignment indication message, and wherein the data channel comprises a physical downlink shared channel.

14. A method comprising:
transmitting, by an apparatus, signaling that carries a timing realignment indication message, the timing realignment indication message including information indicating a timing reference point for realignment; and
receiving, by the apparatus, traffic in a frame, the receiving starting from the timing reference point determined based on the information.

15. The method of claim 14, wherein the information comprises a relative timing and a frame number for a reference frame to which the relative timing relates, and wherein the relative timing is relative to a boundary of a symbol of the reference frame, a slot of the reference frame, a sub-frame of the reference frame, or the reference frame.

16. The method of claim 14, wherein the information comprises an absolute timing indication, and wherein the absolute timing indication comprises at least one of a timestamp or an absolute reference timing.

17. An apparatus comprising:
at least one processor coupled with a non-transitory processor readable medium storing instructions that, when executed by the at least one processor, cause the apparatus to perform operations including:
transmitting signaling that carries a timing realignment indication message, the timing realignment indication message including information indicating a timing reference point for realignment; and
receiving traffic in a frame, wherein the receiving starting from the timing reference point determined based on the information.

18. The apparatus of claim 17, wherein the information comprises a relative timing and a frame number for a reference frame to which the relative timing relates, and wherein the relative timing is relative to a boundary of a symbol of the reference frame, a slot of the reference frame, a sub-frame of the reference frame, or the reference frame.

19. The apparatus of claim 17, wherein the information comprises an absolute timing indication, and wherein the absolute timing indication comprises at least one of a timestamp or an absolute reference timing.

20. The apparatus of claim 17, wherein the signaling comprises group common signaling in a control channel, and wherein the control channel comprises a physical downlink control channel.
